(19) United States
(12) Patent Application Publication
(10) Pub. No.: US 2006/0277253 A1
(43) Pub. Date: Dec. 7, 2006

(54) Method and system for administering network device groups

(76) Inventor: Daniel E. Ford, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/141,884

(22) Filed: Jun. 1, 2005

(51) Int. Cl. G06F 15/16

(52) U.S. Cl. 709/204

(57) ABSTRACT

The preferred embodiment of the present invention is directed to a method for administering custom network device groups for network devices connected in a large network that comprises establishing criteria specifications for one or more custom device groups of network devices, establishing one or more custom device groups based upon said criteria specifications, and assigning each network device to a particular custom device group based upon said device having criteria specifications corresponding to said particular custom device group.

### BACKGROUND OF THE INVENTION

The present invention is generally related to computer networks.

Network administrators of large networks must manage large numbers of network devices. To make these large networks manageable, it is desirable to establish policies or criteria specifications for the configuration and operation of network devices. If such policies are implemented, large numbers of devices can be configured to operate in the same manner and therefore have predictable behavior.

Information technology administrators now use a mechanism of defining device groups to logically group network devices that are present on a network for the purpose of simplifying group operations and other network management tasks that may be required. By defining particular custom device groups and then configuring new devices as they are placed on the network enable devices within each group to be managed and configured or reconfigured as a group and thereby enables more efficient administration of a network. To accomplish this, it is desirable to group devices in ways that makes it easy to apply a single policy to a large number of devices that should share the same policy.

There are formidable problems in implementing such policies. Creating groups can be a very tedious process. A large network may contain thousands of devices, and typical policy groups may contain only a few dozen or perhaps a few hundred devices. Manually picking each desired device out of a very large list is tedious and time consuming. New devices are often added and/or removed from a large network on a daily basis. Each time a new device is added to the network, it is necessary for the network administrator to remember to add it to the appropriate policy groups, so that it can be ensured that it will be included when policies are activated.

### SUMMARY OF THE INVENTION

The preferred embodiment of the present invention is directed to a method for administering custom network device groups for network devices connected in a large network that comprises establishing criteria specifications for one or more custom device groups of network devices, establishing one or more custom device groups based upon said criteria specifications, and assigning each network device to a particular custom device group based upon said device having criteria specifications corresponding to said particular custom device group.

### DESCRIPTION OF THE PREFERRED EMBODIMENTS

Efficient management of the administration of a large area network requires organization and the implementation of procedures that will contribute to the operational stability and efficient and economical management of the network. One mechanism that has been generally used for large area networks is to categorize network devices such as routers, switches, hubs and access points into custom device groups which enable the information technology administration to simplify group operations as well as other network management tasks.

Embodiments of the present invention provide a solution to problems that have been encountered in the past in administering a large area network, by allowing a network administrator to define custom groups more abstractly than in the past. In addition to specifying simple attributes of a group such as a name and a description, the preferred embodiment of the system and method enables rules to be defined, (i.e., actions that are enforced or preferred configurations for devices) that determine what devices belong as members of the group, and conversely what devices should not belong to the group. The system then evaluates the rules against all the devices that are known to exist in the network, and the devices that meet the criteria or specifications set forth in the rules are automatically added to the group. Similarly, if any devices currently in the group no longer meet the criteria or specifications defined by the rules, they are automatically removed from the group.

The system provides significant improvements in the administration of the system for the reason that IT administrators do not have to manually find and add network devices to the various defined groups and they can be confident that as soon as new devices are connected to the network, the system will discover them and automatically add them to the appropriate custom device groups.

Additionally, these rules are automatically evaluated against every new network device as it is discovered. The discovery of new network devices is preferably automatically done by a discovery engine of a network management application that is not, in and of itself a part of the present invention. Thus, as new devices are added to the network, they will automatically be added to the appropriate groups that should contain them, and the policies associated with those groups are automatically applied to the device. This enables devices to be automatically “set-up” without user intervention. This automatic set-up capability is believed to be novel unprecedented in the network management industry.

Examples of rules that might be associated with a group include the following:

1. Devices belonging to a particular manufacturer's specific product line. For example, the rule may specify that all HP ProCurve network devices in the 53xx family of devices would be included in the group. So all 5304's or 5308's discovered would get added to the group.

2. Devices that belong to a particular subnet or range of IP addresses.

3. Devices that have a particular name associated with the “contact” property of a device.

4. Devices that have a particular value in the “location” property of a device. For example, an administrator might wish to have a group for all devices that physically reside in a particular building of a particular campus.

5. Devices with a particular value in the “hostname” property of the device.

6. Devices having a particular operating speed or range of operating speed.

It should also be appreciated that the system can also associate policies with the custom defined groups thereby enabling desired configurations to be enforced on all network devices of specified groups. These policies are preferably capable of being automatically executed with regard to the discovered devices as soon as they are added to a custom device group. Moreover, the policies can be modified at any time and the modifications can be automatically executed with respect to all devices in that particular group. The system thereby eliminates the necessity of performing manual searches for devices that are added to the network. The system also provides a mechanism to implement sets of policies with regard to new devices while insuring that only relevant policies are executed for others by selectively defining different custom groups and the appropriate sets of policies for each group.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A method for categorizing one or more network devices into custom device groups in a network, comprising the steps of:
defining criteria specifications for one or more custom device groups of network devices;
forming one or more custom device groups based upon said criteria specifications;
determining specification related information from each network device; and
assigning each network device to a particular custom device group based upon said device having criteria specifications corresponding to said particular custom device group.

2. A method as defined in claim 1 wherein said criteria specifications comprise at least one specification selected from the group consisting of:
the type of network device;
the manufacturer of said device;
the model designation of said device;
the operating speed of said device;
the product line of the particular manufacturer;
the subnet or range of IP addresses;
the name associated with the contact property;
the value in the “hostname” property;
the value in the “location” property.

3. A method as defined in claim 1 further comprising the step of:
defining operational policies for network devices of a particular custom device group; and
sending said policies to each of the network devices of said particular custom device group to configure said network devices.

4. A method as defined in claim 1 wherein said policies comprise operational configurations and/or required operating actions.

5. A method as defined in claim 1 wherein the network is a wide area network.

6. A method as defined in claim 1 wherein said network devices comprise one or more devices selected from the group consisting of hubs, switches, routers and network access points.

7. A method for administering custom network device groups for network devices connected in a large network, comprising:
establishing criteria specifications for one or more custom device groups of network devices;
establishing one or more custom device groups based upon said criteria specifications; and
assigning each network device to a particular custom device group based upon said device having criteria specifications corresponding to said particular custom device group.

8. A method as defined in claim 7 further comprising:
selectively examining each existing network device to determine its criteria specification related information;
maintaining each network device in its particular custom device group if the criteria specifications of the network device continue to correspond to said particular custom device group; and
removing each network device from its particular custom device group if the criteria specifications of the network device fail to correspond to said particular custom device group.

9. A method as defined in claim 7 further comprising:
determining the criteria specifications of a newly added network device;
comparing said determined criteria specifications with criteria specifications of established custom device groups;
assigning said newly added network device to a particular custom device group based upon said device having criteria specifications corresponding to one of said established custom device groups.

10. A method as defined in claim 7 further comprising modifying the established criteria specifications for all network devices in a custom device group by:
changing the established criteria specifications; and
transmitting to and loading said changed established criteria specifications in all of said network devices in said custom device group.

11. A method as defined in claim 7 wherein said criteria specifications comprise at least one specification selected from the group consisting of:
the type of network device;
the manufacturer of said device;
the model designation of said device;
the operating speed of said device;
the product line of the particular manufacturer;
the subnet or range of IP addresses;
the name associated with the contact property;
the value in the “hostname” property;
the value in the “location” property.

12. A system for administering a plurality of network devices in a large network which operates to
store established predetermined policies relating to the configuration and operating characteristics of various network devices;
stores a plurality of custom network device groups for assigning network devices, each of said custom device groups having a predetermined set of policies;
assigns each network device to a particular custom device group based upon the device satisfying the predetermined set of policies.

13. A system as defined in claim 12 wherein said system
permits predetermined policies to be modified in one or more of said custom device groups;
transmits to and executes modified policies in all of said network devices in said one or more custom device groups in which policies were modified.

14. A system as defined in claim 12 wherein said system
determines the policies of a newly added network device;
compares said determined policies with the sets of policies of said custom device groups; and
assigns said newly added network device to a particular custom device group based upon said device having policies corresponding to those of said established custom device groups.

15. A system as defined in claim 12 wherein said policies further comprise one or more selected from the group consisting of:
the type of network device;
the manufacturer of said device;
the model designation of said device;
the operating speed of said device;
the product line of the particular manufacturer;
the subnet or range of IP addresses;
the name associated with the contact property;
the value in the “hostname” property;
the value in the “location” property.
